(19) United States
(12) Patent Application Publication
(10) Pub. No.: US 2005/0067973 A1
(43) Pub. Date: Mar. 31, 2005

(54) Device for heating electrodes of a discharge lamp

(76) Inventors: Marcel Beij, Eindhoven (NL); Arnold Buij, Eindhoven (NL)

Correspondence Address: U S Philips Corporation;Intellectual Property Department, P O Box 3001, Briarcliff Manor, NY, 10510, US

(21) Appl. No.: 10/495,945

(22) PCT Filed: Nov. 5, 2002
(86) PCT No.: PCT/IB02/04663

(30) Foreign Application Priority Data
Nov. 23, 2001 (EP) 01204531.6

(51) Int. Cl. H05B 37/02; H05B 41/36

(52) U.S. Cl. 315/209 R; 315/212

(57) ABSTRACT

An electronic ballast for operating a discharge lamp comprises a first switch mode power supply for supplying a discharge current to the lamp and a second switch mode power supply for heating the electrodes of the lamp. The second switch mode power supply is equipped with a power control loop comprising a memory for storing at least one electrode heating reference value.

The present invention relates to a device for heating electrodes of a discharge lamp, wherein the lamp is driven by a discharge power generator comprising a switched mode power supply (SMPS) for supplying the discharge power to the lamp.

Ballasts are widely used for providing a controlled power supply to the discharge lamp. Typically, the ballast comprises a preconditioner, for example a double rectifier for rectifying the mains (230 V 50 Hz). The rectified mains (DC bus voltage of 300-400 V) drives a discharge power generator for supplying power to the lamp. The discharge power generator includes a switched-mode power supply (SMPS) connected between the pre-conditioner and the discharge lamp providing a high efficiency AC operation of the lamp. The ballast may for example be employed to maintain a constant power to the discharge lamp for the purpose of maintaining a selected light intensity or may be used for the purpose of controlled dimming of the light intensity of the discharge lamp.

Many types of discharge lamps require heating of the lamp electrodes before the lamp is ignited. Before the ignition phase commences the discharge lamp undergoes a process of preheating of both lamp electrodes. Also during the run-up phase and steady phase the electrodes of the lamp may need heating. In general, the lamp electrodes of the discharge lamp must generate enough emission to obtain a long switching lifetime, a stable lighting process and minimal end blackening.

In some applications electrode heating is accomplished by applying a heating power generator in addition to the above-mentioned discharge power generator. The use of an additional power generator for heating the electrodes, besides the discharge power generator for driving the lamp, permits electrode heating independently from the discharge power supplied to the lamp and may lead to a more precise electrode heating at any moment.

GB 2316 246 A discloses a power generator provided with separate heater circuitry for heating the electrodes of a fluorescent lamp. The heater circuitry maintains the electrodes at a particular temperature. This generator, however, is DC powered and the heater circuitry controls the temperature of the lamp in response to a signal from a temperature sensor and a lamp light sensor. Consequently, the control of the heater circuitry is based on the lamp temperature rather than on the heat supplied to the lamp electrodes. Furthermore, the device is complex and requires a lamp temperature sensor.

It is an object of the present invention to provide a relatively simple device for controlled heating of the electrodes of a discharge lamp.

This object is achieved according to the invention in a device for heating electrodes of a discharge lamp, the lamp being driven by a discharge power generator comprising a switched mode power supply (SMPS) for supplying the discharge power to the lamp, wherein the device comprises:
an electrode heating power generator comprising at least one switching element, primary transformer windings connected to the switching element, and secondary transformer windings connected to one or more of the electrodes of the discharge lamp;
a controller for providing at least one control signal to the switching element for controlling the heating power supplied to the lamp electrodes;
feedback means for feeding a signal representative of the heat dissipated in the electrodes back to the controller;
   wherein the controller comprises a memory in which at least one electrode heating reference value can be prestored and wherein the controller is programmable to control the heating of the electrodes in response to the feedback signal so as to maintain the heat dissipated in the electrodes to the prestored electrode heating reference value. Consequently, the controller compares the actual heating of the electrodes as represented by the feedback signal with a reference value prestored in the controller memory. The controller adjusts or maintains the heating power supplied to the lamp electrodes to or at the prestored reference value. As different lamp types may require different reference values giving an optimal heating result, the prestored reference value preferably corresponds to a heating value which is optimal for the lamp type actually in use.

The controller is in a preferred embodiment provided with a memory in which a plurality of electrode heating reference values each corresponding to a different lamp type can be prestored and wherein the controller is programmable so as to select the electrode heating reference value corresponding to the lamp actually in use. As the optimal heating may differ from lamp type to lamp type>>, this will provide improved heating characteristics for the lamp actually in use. Furthermore, the software controllable lamp heating reference values will make a particular heating device suitable for more than one lamp type. This makes this embodiment of a heating device more versatile, reduces the number of different types of heating devices needed for the different lamp types and reduces the storage capacity of the manufacturer.

In another preferred embodiment the controller is programmed so as to deliver to the electrodes a heating power optimized for the actual discharge power level. For example, before ignition when the actual discharge power level is zero, the electrodes of the lamp may be preheated. Heating the electrodes without the presence of a discharge voltage over the lamp will improve the ignition process. Furthermore, when the lamp is dimmed (during steady phase), the current through the lamp electrodes may become lower than a defined minimum current value. This predefined minimum current value depends inter alia on the type of discharge lamp used. If the lamp current is lower than this minimum current value, the electrodes need to be heated, while if the lamp current is larger than this minimum current value, electrode heating can be turned off. Furthermore, in case the lamp current is lower than the minimum current value, the heating needed will generally increase, as will be explained hereafter.

Therefore the controller comprises in a further preferred embodiment a memory in which a plurality of electrode heating reference values as function of the dimming level can be prestored and the controller is programmable so as to select the electrode heating reference value corresponding to the actual dimming level. The actual dimming level is preferably determined by the controller from a signal representative of the actual dimming level of the discharge lamp in use, which signal is received from the discharge power generator. Consequently, the controller is programmed to adapt the heating power delivered to the electrodes in response to the dimming level of the discharge lamp. In this way a minimum amount of energy is wasted, while the electrode lifetime is optimal.

In another preferred embodiment the controller is programmable so as to determine the actual operational phase of the lamp in use from a signal received from the discharge power generator and so as to select from a plurality of prestored electrode heating reference values prestored in memory the reference value corresponding to the determined operational phase. The optimal operation of the discharge lamp depends on the operational phase of the lamp, i.e. the preheat phase, the ignition phase, the run-up phase, and steady phase or the begin phase or end phase of the lifetime of the lamp, etc. Furthermore, under certain circumstances the lamp operation must satisfy additional requirements. For example, it may be required for specific applications to reduce the start-up time of a lamp from 1,5 s to 0,5 s. This in turn requires a larger amount of heat to be supplied to the lamp electrodes during the preheat phase of the lamp. This can be achieved by specifying adapted reference values for this operational phase of the lamp.

In a further preferred embodiment the controller is programmed so as to shut down the heating power generator when a signal indicative of a short-circuit in any of the electrodes is detected. In that way the transformer of the heating power generator, as explained hereafter, needs to be short circuit proof for only a relatively short time. As a signal indicative of the short-circuit the earlier-mentioned feedback signal may be used.

The heating power generator comprises in a preferred embodiment a pulse-width controlled half-bridge converter with transformer. The half-bridge is suitable for operation from a high voltage supply, typically a DC bus voltage of 300-500 V. The gate drive signals for the switching elements are generated by the controller. By varying the pulse widths of the switching elements of the half-bridge, the voltage across the lamp electrodes can be adjusted. In the embodiment described hereafter the heating power generator includes a first switching element and a second switching element in series, the primary windings of the transformer being connected between the first and second switching element.

The heating power generator comprises in another preferred embodiment a pulse-width controlled flyback converter. In the embodiment described hereafter the flyback converter comprises one switching element connected to a voltage supply through the primary windings of the transformer, and wherein the secondary windings of the transformer are directly connected to the electrodes. Since the secondary windings of the transformer are directly connected to the lamp electrodes, i.e. without intervention of electronic components such as a diode, the electrodes can be AC operated and more heating energy can be provided. Furthermore, this flyback converter circuitry enables operation from bus voltages of up to 400 V or more. Also operation at relatively low voltages V_{dd} (typically 10-15V) are possible using this flyback converter topology.

The feedback means for feeding a signal representative of the heat dissipated in the electrodes back to the controller comprise in another preferred embodiment a resistive element, for example a resistor, connected between a switching element and ground and a shunt for feeding the averaged voltage over the resistive element as feedback signal back to the controller. The average voltage gives a fairly good indication of the energy dissipated in the electrodes of the lamp.

Further advantages, features and details are given in the following description of two preferred embodiments of the invention. In the description reference is made to the annexed Figures, wherein are shown:

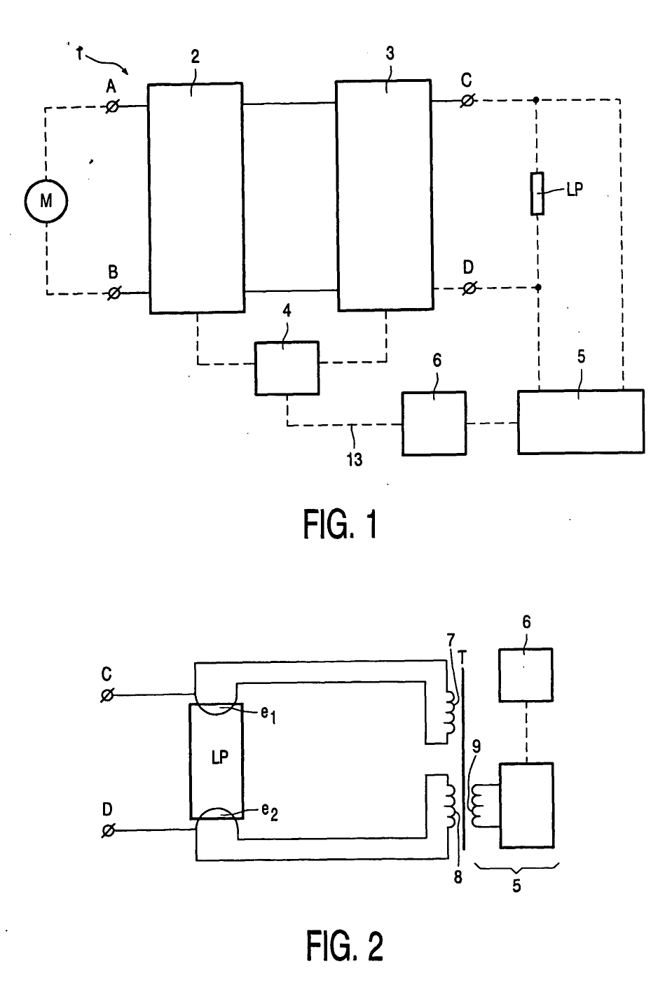

FIG. 1 a schematic diagram of ballast circuitry for operating a discharge lamp and a heating device for heating the electrodes of a lamp;

FIG. 2 a diagram of a part of diagram of FIG. 1;

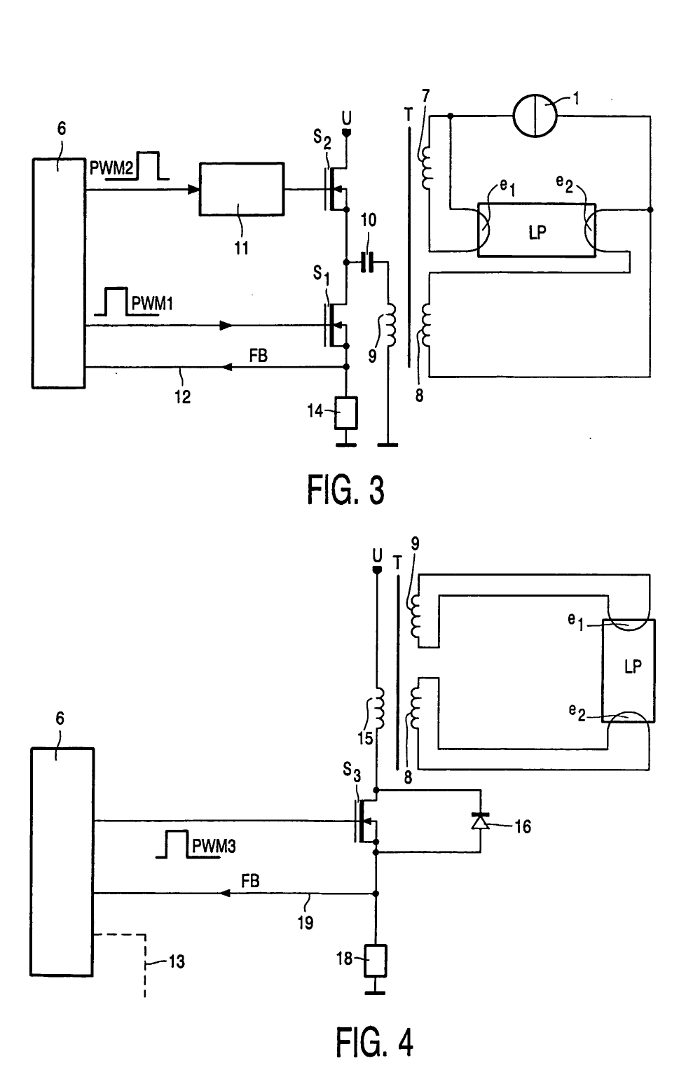

FIG. 3 a schematic diagram of a first embodiment of a lamp electrode heating device;

FIG. 4 a schematic diagram of a second embodiment of a lamp electrode heating device; and

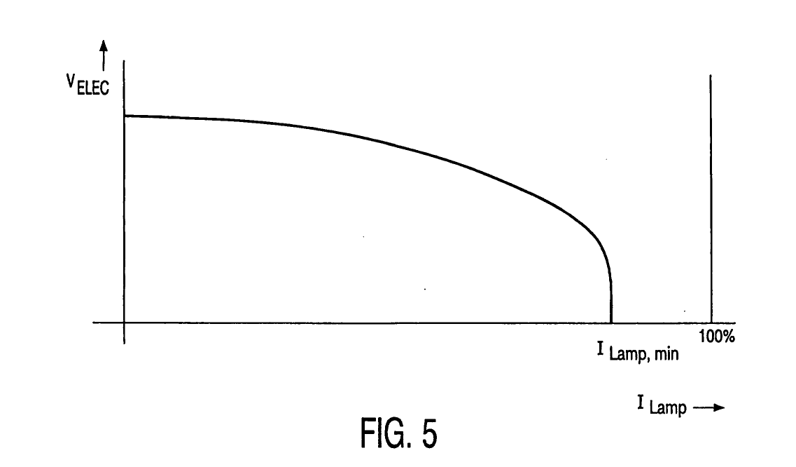

FIG. 5 a graph of the electrode voltage V_{elec} as function of the arc current Iₗₐₘₚ.

In FIG. 1 a operating device 1 (ballast) for operating a discharge lamp LP is provided with input terminals A,B for connection to a power supply, typically the mains M (220 V, 50 Hz). The input terminals A,B connect to a preconditioner 2, which can be a rectifier diode bridge, an up-converter and an energy buffer in series. The diode bridge rectifies the mains M and provides a DC supply voltage or bus voltage U_{DC} between 300 and 500 Volt. The preconditioner 2 is connected to a switched-mode power supply (SMPS) 3. The SMPS provides power to the discharge lamp LP. In case of high frequency operation (low pressure lamps) the switched mode power supply preferably includes a square wave voltage converter, such as a half- or full-bridge converter, for converting the DC supply voltage to a high-frequency AC voltage. In case of square wave current operation the switched mode power supply includes a down-converter and a commutator. The half-/full-bridge circuit or commutator is provided with terminals D,E.

The operation of the ballast 1 is controlled by a ballast controller 4.

Furthermore, the ballast 1 is provided with an external heating device 5 for heating the electrodes of the lamp LP before ignition in the preheat phase and/or after ignition in the run-up or steady state phase. The external heating device 5 may be controlled by a controller 6.

In FIG. 2 a part of the circuitry of FIG. 1 is shown in more detail. More specifically, FIG. 2 shows the heating device 5 and its controller 6. Optionally between the ballast controller 4 and the heating device controller 6 a transmission line 13 is provided for transmitting data between both controllers. Further are shown lamp electrodes e₁,e₂, which are connected to respectively secondary windings 7 and 8 of a transformer T. The primary windings 9 of transformer T are part of the heating device 5.

In FIG. 3 a first preferred embodiment of the heating device 5 is shown. The heating device 5 is realized as a half-bridge converter with transformer T. The half-bridge comprises a cascade of a first switching element S₁ and a second switching element S₂. The second switching element S₂ may be connected to any suitable power supply, for example the bus voltage U_{DC} supplied by the preconditioner 2 of the discharge power generator (depicted in FIG. 3 as a current source 1). Between the first and second switching elements the primary windings 9 of the transformer T are connected (via a capacitor 10). Control of the switching elements is provided by the programmable microcontroller 6, which includes a memory and a processor (not shown). The microcontroller 6 provides a first pulse-width modulated (PWM) control signal PWM1 to the first switching element S₁ and a second pulse-width modulated control signal PWM1 through a level shifter 11 to the second switching element S₂.

In a further preferred embodiment (not shown) a relatively small resistance is included in the source lines of the switching elements as a result of which a short circuit situation can better be handled.

By varying the pulse widths of PWM1 and PWM2 the voltage across the lamp electrodes e₁,e₂ and hence the heating power supplied to the lamp electrodes can be controlled. Furthermore, between ground and the first switching element S₁ an ohmic resistor 14 is connected and a shunt 12 with the microcontroller 6 is provided. Through the shunt 12 a feedback signal FB may be supplied to the controller 6. The feedback signal is the averaged voltage over the resistor 14 and is used to monitor the power (current*supply voltage) drawn by the heating device 5. This power is representative of the heating energy actually dissipated by the electrodes e₁,e₂ of the lamp LP. The feedback loop establishes an improved control of the power actually supplied to the lamp electrodes.

In FIG. 4 a second preferred embodiment of the heating device 5 is shown. In this embodiment the heating device 5 is realized as a flyback converter in combination with a transformer T. The flyback converter comprises a switching element S₃ which is connected to a voltage supply U through the primary windings 15 of transformer T. Diode 16 protects switching element S₃ against the voltage spike that is caused by the uncoupled inductance of the transformer T when the switching element S₃ switches off. The secondary windings 7 and 8 of transformer T are directly connected to the electrodes e₁,e₂ of the lamp LP. Switching element S₃ is controlled by a microcontroller 6. The microcontroller 6 generates a square wave voltage signal PWM3 with variable pulse width and fixed frequency. During the preheat phase the pulse width is at a maximum value, causing a maximum heating of the lamp electrodes, during operation of the lamp the pulse width may be less, depending on the amount of heating needed. During dimmed operation of the lamp, i.e. when the output discharge power of the ballast 1 is set to a reduced dim level, the ballast controller 4 provides a dim control signal representative of the set dim level through transmission line 13 to the controller 6 of the heating device. Microcontroller 6 determines the correct pulse width of the control signal supplied to the switching element S₃ for each value of the dim control signal and controls the switching element S₃ accordingly.

The flyback converter of the present embodiment may be connected to a low DC voltage supply, for example a voltage V_{dd} of about 12 V also used as operating voltage of the microcontroller. However, since the secondary windings of the transformer T is directly connected to the electrodes e₁,e₂ of the lamp and lack a diode element, an AC voltage supply may be used as a result of which more heating energy can be supplied to the electrodes.

Furthermore, between ground and the switching element S₃ an ohmic resistor 18 is connected and a shunt 19 to the microcontroller 6 is provided. Through the shunt 19 a feedback signal FB may be supplied to the controller 6. As mentioned earlier, the feedback signal is the averaged voltage over the resistor 18 and is used to monitor the power (current*supply voltage) drawn by the heating device 5. This power is representative of the heating energy actually dissipated by the electrodes e₁,e₂ of the lamp LP.

In the memory of the controller 5 a plurality of electrode heating power references for different lamp types are stored, wherein each power reference belongs to a specific lamp type. As different lamp types may require a different amount of heating energy during the various operational phases (pre-ignition, ignition, run-up, steady operation at full or dimmed level), the prestored reference value relating to a specific lamp type is set to correspond to an amount of energy which is optimal for this specific lamp type. The controller 5 is able to select that power reference value which corresponds with the type of lamp actually in use. The selection may be achieved by user intervention, for example after indicating through hardware or software to the controller which lamp type is present between the lamp terminals C/D, or may be achieved automatically, when the control circuitry is provided with means for determining the type of the lamp present.

Besides on the lamp type, the optimum electrode heating power may be depending on the dimming level. The microcontroller 6 in this case is programmed to control the heating power generator, i.e. the half bridge of FIG. 3 or the flyback converter of FIG. 4, such that the electrodes are heated when the lamp is dimmed and the lamp current, as provided by the discharge power generator, becomes smaller than a predefined minimum current value I_{lamp,min}. When the lamp is further dimmed and the lamp current is further reduced, the controller 6 will have the heating power generator supply more power to increase the heating of the lamp electrodes. The control behaviour is further elucidated in FIG. 5. FIG. 5 shows a curve representing the electrode voltage V_{elec} as function of the lamp current Iₗₐₘₚ through one of the lamp electrodes. For simplicity the curve of the electrode voltage as function of the lamp voltage of the other electrode is omitted. However, this curve will in general be identical to the curve earlier mentioned as both electrodes will be heated similarly.

When the lamp is operated at a 100% level, there is no need to heat the electrodes additionally using the heating device. However, when the lamp is dimmed and the lamp current Iₗₐₘₚ is reduced until the lamp current reaches the minimum lamp current I_{lamp,min}, the electrodes need additional heating by the heating device. The smaller the lamp current, the more the electrodes need additional heating by the heating device. In this way the lifetime of the electrodes will be increased while a minimum amount of energy is wasted.

The actual dimming level may determined by the controller from a signal representative of the actual dimming level of the discharge lamp in use. This signal is generated by the microcontroller 4 of the discharge power device 1 and is transmitted through transmission line 13 (FIG. 1) to the microcontroller 6 of the heating power device 5. The microcontroller 6 is programmed to adapt the heating power delivered to the electrodes in response to the dimming level signal. In this way energy may be saved and the lifetime of the electrodes may be prolonged.

The amount of heating needed may furthermore depend on the operational phase of the lamp, which information may be derived from the ballast controller 4. A signal representative of the operational phase of the lamp is in this case generated by the ballast controller 4 and transmitted to the heating device controller 6. Then the controller 6 selects from its memory the reference value that will give a heating which is optimized for the present lamp type and the present operational phase of the lamp.

In a further embodiment the microcontroller 6 is programmed to detect a signal that indicates a short circuit in any of the lamp electrodes e₁,e₂. This signal may be the above-mentioned feedback signal or any other signal suitable for this purpose. Upon detection of a short circuit, the microcontroller 6 interrupts the pulse-width modulated control signal PMW1 (control signal PMW2 and/or PWM3). As a result the heating power generator 5 is shut down. Therefore the heating power generator 5 needs to be short circuit proof for only a relatively short time and the circuitry may be simplified accordingly.

In the above embodiments the controller 4 of the operating device 1 and the controller of the heating device 5 comprise two separate microcontrollers. However, a combination of the controller 4 of the operating device 1 and the controller 6 of the heating device 5 into one microcontroller may be conceivable as well. This will further simplify the design and implementation of the circuitry.

The present invention is not limited to the above described preferred embodiments thereof; the rights sought are defined by the following claims, within the scope of which many modifications can be envisaged.

1. Device for heating electrodes of a discharge lamp, the lamp being driven by a discharge power generator comprising a switched mode power supply (SMPS) for supplying the discharge power to the lamp, the device comprising:
an electrode heating power generator comprising at least one switching element, primary transformer windings connected to the switching element, and secondary transformer windings connected to one or more of the electrodes of the discharge lamp;
a controller for providing at least one control signal to the switching element for controlling the heating power supplied to the lamp electrodes;
feedback means for feeding a signal representative of the heat dissipated in the electrodes back to the controller; wherein the controller comprises a memory in which at least one electrode heating reference value can be prestored and wherein the controller is programmable to control the heating of the electrodes in response to the feedback signal so as to maintain the heat dissipated in the electrodes to the prestored electrode heating reference value.

2. Device according to claim 1, wherein the at least one control signal is a pulse width modulated signal provided by the controller to the at least one switching element.

3. Device according to claim 1, wherein the heating power generator comprises a pulse-width controlled half-bridge converter with transformer.

4. Device according to claim 3, wherein the half-bridge converter comprises a first switching element (S₁) and a second switching element (S₂) in series and wherein the primary windings of the transformer are connected between the first and second switching element.

5. Device according to claim 4, comprising a level shifter for shifting the level of the pulse-width modulated (PWM) control signal of the second switching element (S₂).

6. Device according to claim 1, wherein the heating power generator comprises a pulse-width controlled flyback converter.

7. Device according to claim 6, wherein the flyback converter comprises one switching element (S₃) connected to a voltage supply through the primary windings of the transformer, and wherein the secondary windings of the transformer are directly connected to the electrodes.

8. Device according to claim 1, wherein the feedback means comprise a resistive element connected between a switching element and ground and a shunt for feeding the averaged voltage over the resistive element as feedback signal back to the controller.

9. Device according to claim 1, wherein the controller is programmed so as to deliver to the electrodes a heating power optimized for the actual discharge power level.

10. Device according to claim 1, wherein the controller comprises a memory in which a plurality of electrode heating reference values each corresponding to a different lamp type can be prestored and wherein the controller is programmable so as select the electrode heating reference value corresponding to the lamp actually in use.

11. Device according to claim 1, wherein the controller comprises a memory in which a plurality of electrode heating reference values as function of the dimming level can be prestored and the controller is programmable so as to select the electrode heating reference value corresponding to the actual dimming level.

12. Device according to claim 11, wherein the controller is programmable so as to determine the actual dimming level from a signal representative of the actual dimming level of the discharge lamp in use received from the discharge power generator.

13. Device according to claim 1, wherein the controller is programmable so as to determine the actual operational phase of the lamp in use from a signal received from the discharge power generator and so as to select from a plurality of prestored electrode heating reference values prestored in memory the reference value corresponding to the determined operational phase.

14. Device according to claim 1, wherein the controller is programmed so as to shut down the heating power generator when a signal indicative of a short-circuit in any of the electrodes is detected.

15. Device according to claim 14, wherein the signal indicative of the short-circuit is the feedback signal.
